(19) United States
(12) Patent Application Publication
(10) Pub. No.: US 2012/0141723 A1
(43) Pub. Date: Jun. 7, 2012

(54) POLYMER FIBER CONTAINING FLAME RETARDANT, PROCESS FOR PRODUCING THE SAME, AND MATERIAL CONTAINING SUCH FIBERS

(76) Inventors: Hoe Hin Chuah, Houston, TX (US); Kailash Dangayach, Houston, TX (US); Venkataratnam Ramachandran, Dalton, GA (US)

(21) Appl. No.: 11/939,437

(22) Filed: Nov. 13, 2007

Related U.S. Application Data
(60) Provisional application No. 60/865,990, filed on Nov. 15, 2006.

(51) Int. Cl. C08K 5/5313; B29C 47/00; C08L 67/00; D05C 17/02; C08L 67/02; C08L 77/00

(52) U.S. Cl. 428/85; 524/133; 428/221; 264/176.1

(57) ABSTRACT

The present invention provides a polymer fiber containing a flame retardant. In particular, the invention provides a fiber containing poly(trimethylene terephthalate) and a flame retardant that melts at a temperature of equal to or below 280° C. The present invention also provides a process for producing such a fiber, and a material incorporating such fibers.

### CROSS REFERENCE TO EARLIER APPLICATION

The present application claims the benefit of the filing date of U.S. Provisional patent application Ser. No. 60/865,990 filed Nov. 15, 2006, the disclosure of which is incorporated herein by reference.

### FIELD OF THE INVENTION

The present invention is directed to a polymer fiber containing a flame retardant, a process for producing the fiber, and materials containing the fiber. More particularly, the present invention is directed to a polymer fiber containing a flame retardant comprising a phosphinate metal salt having a melting point equal to or below 280° C., a process for producing the same, and a material containing such fibers.

### BACKGROUND OF THE INVENTION

Flame retardants are frequently added to or incorporated in polymers to provide flame retardant properties to the polymers. The flame retardant polymers may then be spun into fibers that may be used in applications in which resistance to flammability is desirable, for example, in textile or carpet applications.

A large variety of compounds have been used to provide flame retardancy to polymers. For example, numerous classes of phosphorous containing compounds and nitrogen containing compounds have been utilized as flame retardants in polymers. Classes of such phosphorous containing compounds include inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphinic, phosphoric, and phosphonic acids. The metal salts of phosphinic acids (metal salt phosphinates) that have been utilized as flame retardants in polymers comprise a large variety of compounds themselves, including monomeric, oligomeric, and polymeric species with one, two, three, or four phosphinate groups per coordination center including metals selected from beryllium, magnesium, calcium, strontium, barium, titanium, zirconium, vanadium, antimony, bismuth, chromium, molybdenum, tungsten, manganese, iron, ruthenium, cobalt, rhodium, iridium, nickel, platinum, palladium, copper, silver, zinc, cadmium, mercury, aluminum, tin, and lead. Such flame retardant compounds have been used in a wide variety of polymers.

For example, phosphorous containing compounds have been used as flame retardants in polymers such as polymers of mono- and di-olefins such as polypropylene, polyisobutylene, polyisoprene, and polybutadiene; aromatic homopolymers and copolymers derived from vinyl aromatic monomers such as styrene, vinylnaphthalene, and p-vinyltoluene; hydrogenated aromatic polymers such as polycyclohexylethylene; halogen containing polymers such as polychloroprene and polyvinylchloride; polymers derived from α,β-unsaturated acids and derivatives thereof such as polyacrylates and polyacrylonitriles; polyamides such as poly(e-caproamide) sold as NYLON-6 and poly(hexamethylene adipamide) sold as NYLON-6,6, and polyesters such as polyethylene terephthalate (PET), and polybutylene terephthalate (PBT).

Poly(trimethylene terephthalate) (“PTT”) is a polyester that has recently been commercially developed as a result of the recent availability of commercial quantities of 1,3-propanediol, a requisite monomer for forming PTT. PTT has an array of desirable characteristics when used in fiber applications relative to other polymers used in fiber applications such as polyamides, polypropylenes, and its polyester counterparts PET and PBT, such as soft touch, resilience and shape recovery due to its spring-like molecular structure, and good stain resistance.

It is desirable to provide PTT fibers with flame retardant properties by incorporating a flame retardant in PTT fibers. Incorporation of a flame retardant in a PTT fiber, however, has proven difficult since PTT fibers containing effective amounts of flame retardants are prone to breakage during spinning of the fiber due to the presence of the flame retardant in the PTT. As a result, a PTT fiber having a high tenacity, for example a tenacity of at least 1 gram per denier (g/d), and an effective amount of flame retardant has proven elusive. A PTT fiber having a high tenacity is necessary to produce quality yarns, carpets, and textiles from the PTT fiber. It would be useful to have a PTT fiber containing a highly effective flame retardant in which the fiber has a tenacity of at least 1 g/d, where the fiber has reduced flame retardant induced breakage when melt spun relative to presently available PTT fibers containing flame retardants.

U.S. Pat. Nos. 4,180,495; 4,208,321; and 4,208,322 provide poly(metal phosphinate) flame retardants that may be added to polyester resins, polyamide resins, or polyester-polyamide resins. Among several other applications, the resins may be spun into fibers and thereafter be made into fabric and clothing. One of the polyester resins to which such flame retardants may be added is PTT. The list of poly(metal phosphinate) flame retardants that may be added to the polyester, polyamide, or polyester-polyamide resins is extensive, and includes the metal salts of phosphinic acids (metal salt phosphinates) listed above—e.g. monomeric, oligomeric, and polymeric species with one, two, three, or four phosphinate groups per coordination center including metals selected from beryllium, magnesium, calcium, strontium, barium, titanium, zirconium, vanadium, antimony, bismuth, chromium, molybdenum, tungsten, manganese, iron, ruthenium, cobalt, rhodium, iridium, nickel, platinum, palladium, copper, silver, zinc, cadmium, mercury, aluminum, tin, and lead. The poly(metal phosphinate) flame retardants may be utilized in the polymers in an amount from 0.25 to 30 parts by weight per 100 parts by weight of polymer resin. These references, however, do not provide a PTT fiber having a high tenacity, e.g. a tenacity of at least 1 g/d, containing an effective flame retardant since they do not provide a PTT fiber that is not prone to breakage in melt spinning due to the presence of the flame retardant in the PTT.

U.S. Patent Publication No. 2005/0272839 provides a compression granulated flame retardant composition containing a) a pulverulent phosphinate and/or diphosphinate and/or their polymers as a flame retardant and b) a fusible zinc phosphinate as a compacting agent that may have some flame retardant activity. The phosphinates or diphosphinates are metal salts in which the metal is Mg, Ca, Al, Sb, Sn, Ge, Ti, Zn, Fe, Zr, Ce, Bi, Sr, Mn, Li, Na, and/or K. The fusible zinc phosphinate has a melting point of from 40° C. to 250° C. The phosphinates or diphosphinates comprise from 50 to 98 wt. % of the compression-granulated flame retardant composition, and the fusible zinc phosphinate forms from 2 to 50 wt. % of the flame retardant composition. The compression granulated flame retardant may be used in a large variety of polymers including polyesters, specifically including PET and PBT. The polymers treated with the compression granulated flame retardant are useful to produce polymer filaments and polymer fibers as well as polymer moldings, and the treated polymers may contain from 1 to 70% by weight of the compression granulated flame retardant. The reference, however, does not provide a PTT polymer fiber having a high tenacity, e.g. a tenacity of at least 1 g/d, containing an effective flame retardant since the reference does not provide PTT fiber that is not prone to breakage in melt spinning due to the presence of the flame retardant in the PTT.

### SUMMARY OF THE INVENTION

In one aspect, the invention is directed to a flame retardant polyester fiber comprising (a) a polymer comprised of at least 75 wt. % poly(trimethylene terephthalate) comprised of at least 75 mol % trimethylene terephthalate; and (b) a flame retardant comprising a flame retardant phosphinate metal salt having a melting point equal to or below 280° C.; wherein said phosphinate metal salt comprises from 0.25 wt. % to 5 wt. % of the fiber and wherein the phosphinate metal salt comprises at least 10 wt. % of the flame retardant; the fiber having a tenacity of at least 1 g/d and a length at least 100 times its width.

In another aspect, the invention is directed to a material comprising a plurality of fibers wherein at least 5% of the fibers are comprised of (a) a polymer comprised of at least 75 wt. % poly(trimethylene terephthalate) comprised of at least 75 mol % trimethylene terephthalate; and (b) a flame retardant comprising a flame retardant phosphinate metal salt having a melting point equal to or below 280° C.; wherein the phosphinate metal salt comprises from 0.25 wt. % to 5 wt. % of the flame retardant poly(trimethylene terephthalate) fibers and wherein the phosphinate metal salt comprises at least 10 wt. % of the flame retardant of the flame retardant poly(trimethylene terephthalate) fibers.

In another aspect, the invention is directed to a process for producing a flame retardant polyester fiber comprising mixing a flame retardant comprising a flame retardant phosphinate metal salt and a polymer comprising at least 75 wt. % poly(trimethylene terephthalate) comprised of at least 75 mol % trimethylene terephthalate at a temperature of from 180° C. to 280° C. to form a mixture; and passing the mixture through a spinneret to form a fiber, wherein (a) the temperature at which the flame retardant and the polymer are mixed is selected so that the phosphinate metal salt and the polymer each have a melting point below the selected temperature; (b) the flame retardant is selected so that the phosphinate metal salt comprises at least 10 wt. % of the flame retardant; (c) the amount of flame retardant mixed in the mixture is selected so the phosphinate metal salt comprises from 0.25 wt. % to 5 wt. % of the mixture; and (d) the amount of flame retardant mixed in the mixture is selected to provide a fiber having a tenacity of at least 1 g/d upon passing the mixture through the spinneret to form the fiber.

### BRIEF DESCRIPTION OF THE DRAWINGS

Advantages of the present invention will become apparent to those skilled in the art with the benefit of the following detailed description and upon reference to the accompanying drawings in which:

FIG. 1 is a schematic of a process for producing a fiber of the present invention incorporated into a yarn.

FIG. 2 is a schematic of a process for producing a fiber of the present invention as a bulk continuous filament.

### DETAILED DESCRIPTION OF THE INVENTION

The present invention provides a polyester PTT fiber containing a flame retardant in which the fiber has an effective degree of flame retardancy, has a tenacity of at least 1 g/d, and has reduced flame retardant induced breakage when the fiber is spun relative to presently available PTT fibers containing flame retardants, or in which flame retardant induced breakage when the fiber is spun is eliminated. The PTT fiber of the present invention may contain only a minor amount of a flame retardant therein, where the flame retardant includes at least one flame retardant phosphinate metal salt having a melting point equal to or below 280° C. (hereinafter such phosphinate metal salt(s), either singular or plural, may be referred to as a “meltable phosphinate metal salt”). The flame retardant containing PTT fiber of the invention has an effective degree of flame retardancy since 1) the meltable phosphinate metal salt in the fiber has been found to possess sufficient flame retardancy in and of itself to provide effective flame retardancy in a PTT fiber; and 2) the meltable phosphinate metal salt of the flame retardant is well dispersed in the fiber due to its melting point being equivalent to or below the temperature at which the PTT fiber is melt spun thereby providing the fiber with a well distributed flame retardant. It is possible to form the flame retardant containing PTT fiber of the present invention since 1) the fiber may contain little or no particulate flame retardants, which may induce breakage of PTT fiber as it is melt spun, particularly if the particle size is relatively large, for example, a mean particle diameter of greater than 10 microns or if the particle quantity is relatively large, for example, more than 15 wt. % of the fiber; and 2) the fiber contains insufficient meltable phosphinate metal salt, for example greater than 5 wt. %, to induce an intrinsic viscosity in the polymer too low for the fiber to be formed in a melt spinning process and/or to reduce the tenacity of the fiber to below 1 gram per denier (g/d).

The flame retardant polymer fiber of the present invention contains a polymer comprising at least 75 wt. % poly(trimethylene terephthalate) comprised of at least 75 mol % trimethylene terephthalate (the “PTT polymer”) and a flame retardant comprising a flame retardant phosphinate metal salt having a melting point of equal to or below 280° C. The flame retardant meltable phosphinate metal salt comprises from 0.25 wt. % to 5 wt. % of the fiber. The fiber has a tenacity of at least 1 g/d. In an embodiment, the flame retardant meltable phosphinate metal salt may comprise greater than 50 wt. % of the flame retardant.

The PTT polymer may be a homopolymer, a PTT co-polymer containing minor amounts of non-PTT co-monomers, a blend of a PTT homopolymer with minor amounts of other polymers, or a PTT co-polymer containing minor amounts of non-PTT co-monomers blended with minor amounts of other polymers. The PTT polymer, regardless of other non-PTT co-monomers or other polymers therein, contains at least 75 wt. %

poly(trimethylene terephthalate) comprised of at least 75 mol % trimethylene ephthalate.

“Non-PTT co-monomers” as used herein, are defined as monomers in a polymer containing repeating trimethylene terephthalte units that may replace at least one of the monomers that form trimethylene terephalate units, specifically 1,3-propanediol and terephthalic acid or dimethylesterterephthalate, and be incorporated into the polymeric chain without forming a trimethylene terephthalate unit. Such non-PTT co-monomers include, but are not limited to, ethylene glycol, 1,4-butanediol, 1,4 cyclohexanedimethanol, oxalic acid, succinic acid, phthalic acid, 2,6-naphthalenedicarboxylic acid, 5-sodiumsulfoisophthalic acid, isophthalic acid, and/or adipic acid. The PTT polymer of the flame retardant polymer fiber may contain up to 25 mol % non-PTT co-monomers, or may contain at most 15 mol %, or at most 10 mol %, or at most 5 mol % non-PTT co-monomers. The PTT polymer of the fiber of the present invention may contain no non-PTT co-monomers (i.e., the PTT polymer is a homopolymer).

Other polymers that may be included in the flame retardant polymer fiber of the present invention along with the PTT include polyesters such as poly(ethylene terephthalate), poly(butylene terephthalte), poly(ethylene naphthalate) and poly(trimethylene naphthalate), and polyamides such as poly(e-caproamide) (NYLON-6) and poly(hexamethylene adipamide)(NYLON-6,6). In one embodiment, NYLON-6 or NYLON-6,6 is included with PTT in the fiber of the invention to offset some or all tenacity reduction that may be induced in the PTT polymer fiber as a result of the presence of the flame retardant meltable phosphinate metal salt in the fiber. The other polymers that may be included in the fiber of the present invention with PTT do not exceed 25 wt. %, or 15 wt. %, or 10 wt. %, or 5 wt. % of the fiber. In another embodiment of the fiber of the invention, PTT may be present in the fiber in a weight ratio to other polymers of at least 3:1, or at least 4:1, or at least 5:1, or at least 6:1. In an embodiment, no other polymer is present in the flame retardant PTT polymer fiber than PTT itself.

The flame retardant PTT polymer fiber of the present invention has a tenacity of at least 1 g/d. In an embodiment of the fiber of the present invention, the fiber may have a tenacity of at least 1.3 g/d, or at least 1.4 g/d, or at least 1.5 g/d. Tenacity, for purposes of the present invention, is measured with a Statimat ME tester with a load cell of 100 newtons. A pretension force of 0.05 g/d is applied to the fiber/yarn with a gauge length of 110 mm, and the tenacity is measured at a cross-head speed of 300 mm/min. The test is repeated ten times on segments of a selected yarn or fiber, and the average value of the ten measurements is defined as the tenacity of the yarn or fiber for purposes of the present invention.

The flame retardant PTT polymer fiber of the present invention contains a flame retardant that contains a flame retardant meltable phosphinate metal salt having a melting point equal to or below 280° C., or below 270° C., or below 250° C., or below 230° C., or below 200° C., or below 180° C. The phosphinate metal salt comprises from 0.25 wt. % to 5 wt. % of the fiber, or may comprise from 0.3 wt. % to 4 wt. %, or from 0.5 wt. % to 2.5 wt. % of the fiber.

The flame retardant meltable phosphinate metal salt comprises at least 10 wt. % of the flame retardant in the flame retardant PTT polymer fiber of the present invention. The flame retardant meltable phosphinate metal salt may comprise greater than 50 wt. % of the flame retardant in the flame retardant PTT polymer fiber, or may comprise at least 75 wt. % of the flame retardant in the fiber. The flame retardant in the flame retardant PTT polymer fiber of the invention may consist essentially of the flame retardant meltable phosphinate metal salt.

The flame retardant meltable phosphinate metal salt(s) may be any phosphinate metal salt having the structure shown in formula (I) and having a melting point equal to or below 280° C., or below 270° C., or below 250° C., or below 230° C., or below 200° C., or below 180° C.

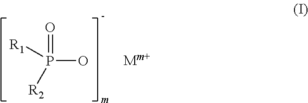

In formula (I), R₁ and R₂ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4. The flame retardant phosphinate metal salt must have a melting point equal to or below 280° C., or below 270° C., or below 250° C., or below 230° C., or below 200° C., or below 180° C. so that it may be melted and dispersed in the PTT polymer at a temperature that will not substantially degrade the polymer so that the combined flame retardant meltable phosphinate metal salt and PTT polymer may be spun to form the fiber.

In a preferred embodiment, the flame retardant meltable phosphinate metal salt is a zinc phosphinate having a melting point equal to or below 280° C., or below 270° C., or below 250° C., or below 230° C., or below 200° C., or below 180° C. and having the structure of formula (I) where R₁ and R₂ are identical or different and are hydrogen, C₁-C₁₈ alkyl, linear or branched, and/or aryl, M is zinc, and m is 2. In one embodiment the zinc phosphinate has a melting point of equal to or below 280° C., or below 270° C., or below 250° C., or below 230° C., or below 200° C., or below 180° C. and is of the formula (I), where R₁ and R₂ are identical or different and are methyl, ethyl, isopropyl, n-propyl, t-butyl, n-butyl, or phenyl, M is zinc, and m is 2. In a preferred embodiment, the zinc phosphinate is selected from the group consisting of zinc diethylphosphinate, zinc dimethylphospinate, zinc methylethylphosphinate, zinc diphenylphosphinate, zinc ethylbutylphosphinate, and zinc dibutylphosphinate. In a most preferred embodiment, the zinc phosphinate is zinc diethylphosphinate.

The flame retardant of the flame retardant PTT polymer fiber of the invention may contain a flame retardant component that does not have a melting point equal to or below 280° C., which is defined for purposes of the present invention as the “non-fusible flame retardant component”. The non-fusible flame retardant component of the flame retardant, if present, does not have a melting point equal to or below 280° C., although the non-fusible flame retardant component may, but does not necessarily, have a melting point above 280° C. since the non-fusible flame retardant component may decompose rather than melt. Such non-fusible flame retardant components include phosphinate metal salts of the formula (I) that do not melt at a temperature equal to or below 280° C., other phosphorous containing compounds that are non-fusible at a temperature equal to or below 280° C., including inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphoric, and phosphonic acids, diphosphinic salts, and nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate. Melamine cyanurate is a preferred non-fusible flame retardant used in the fiber of the present invention.

In an embodiment of the fiber of the present invention, the flame retardant may contain less than 90 wt. %, or less than 50 wt. %, or less than 35 wt. %, or less than 25 wt. %, or less than 10 wt. %, or less than 5 wt. % of the non-fusible flame retardant component, or may contain no non-fusible flame retardant component. If present, the non-fusible flame retardant component of the flame retardant in the fiber may be particulate. The average particle size of the non-fusible flame retardant component of the composition may range up to 10 μm, although it is preferred that the average particle size is at most 3 μm, and even more preferred that the particles are nanoparticles having an average particle size less than 1μ. A smaller average particle size of the non-fusible flame retardant in the fiber provides at least two benefits in the fiber: 1) more homogeneous dispersion of the particulate flame retardant in the fiber, resulting in better flame retardancy; and 2) reduced fiber breakage as the fiber is melt spun as a result of large particulates in the spun fiber. In an embodiment, the non-fusible flame retardant component of the flame retardant is melamine cyanurate having a mean particle size of at most 3 μm.

The flame retardant including the flame retardant meltable phosphinate metal salt and, if present, a non-fusible flame retardant component, may be present in the flame retardant PTT polymer fiber in an amount of up to 15 wt. % of the fiber, or up to 10 wt. % of the fiber, or up to 5 wt. % of the fiber, or up to 2.5 wt. % of the fiber—where the meltable phosphinate metal salt may be present only up to 5 wt. % of the fiber. In an embodiment of the fiber of the present invention, the flame retardant may be present in the flame retardant PTT polymer fiber in an amount of from 0.25 wt. % to 15 wt. %, or from 0.3 wt. % to 10 wt. %, or from 0.5 wt. % to 5 wt. %.

In an embodiment of the invention, the flame retardant PTT polymer fiber may contain a filler. “Filler” as the term is used herein is defined as “a particulate or fibrous material having no flame retardant activity”. Too much filler may negatively affect the melt spinning of the fiber of the present invention by inducing breakage in the fiber as it is spun, therefore, the fiber may contain from 0 wt. % to 5 wt. % filler, or may contain from 0 wt. % to 3 wt. % filler. In an embodiment of the fiber of the present invention, a filler may be included in the fiber as a delusterant. A preferred filler for inclusion in the fiber as a delusterant is titanium dioxide. Other examples of filler materials that may be included in the fiber include fibrous materials such as glass fiber, asbestos fiber, carbon fiber, silica fiber, fibrous woolastonite, silica-alumina fiber, zirconia fiber, potassium titanate fiber, metal fibers, and organic fibers with melting points above 300° C.; and particulate or amorphous materials such as carbon black, white carbon, silicon carbide, silica, powder of quartz, glass beads, glass powder, milled fiber, silicates such as calcium silicate, aluminum silicate, clay, and diatomites, metal oxides such as iron oxide, zinc oxide, and alumina, metal carbonates such as calcium carbonate and magnesium carbonate, metal sulfates such as calcium sulfate and barium sulfate, and metal powders.

The fiber of the present invention may be undrawn, partially oriented, or fully oriented depending on the conditions used to produce the fiber. An undrawn fiber of the present invention is defined herein as a fiber comprising a PTT polymer, as defined above, and a flame retardant, as defined above, and having an elongation to break of at least 120%. The undrawn fiber may have a birefringence of less than 0.3 or less than 0.2. A partially oriented fiber of the present invention is defined herein as a fiber comprising a PTT polymer, as defined above, and a flame retardant, as defined above, and having an elongation to break of from 50% up to 120%. The partially oriented fiber may have a birefringence of from 0.3 up to 0.9. A fully oriented fiber of the present invention is defined herein as a fiber comprising a PTT polymer, as defined above, and a flame retardant, as defined above, and having an elongation to break of up to 50%. The fully oriented fiber may have a birefringence of greater than 0.9.

The fiber of the present invention has fiber-like dimensions, namely, that the length of the fiber is much greater than the width or diameter of the fiber. The fiber has a length of at least 100 times the width of the fiber, and, in one embodiment, has a length of at least 1000 times the width of the fiber. In one embodiment the fiber may be a filament, e.g. a fiber of extreme length. In one embodiment the fiber is a bulk continuous filament in which the filament has been textured, e.g. by jet air texturing, to provide the filament with bulk. In another embodiment, the fiber may be a staple fiber.

In one aspect, the present invention is directed to a process for producing the fiber of the present invention in which a flame retardant comprising at least one flame retardant meltable phosphinate metal salt having a melting point of equal to or below 280° C., or below 270° C., or below 250° C., or below 230° C., or below 200° C., or below 180° C. and a polymer comprising at least 75 wt. % poly(trimethylene terephthalate) comprised of at least 75 mol % trimethylene terephthalate (the “PTT polymer” as noted above) are mixed at a temperature of from 180° C. to 280° C. to form a mixture, and then the mixture is passed through a spinneret to form the fiber. The temperature at which the flame retardant meltable phosphinate metal salt and the PTT polymer are mixed is selected so that the meltable phosphinate metal salt and the PTT polymer each have a melting point below the selected temperature to ensure the flame retardant meltable phosphinate metal salt and the PTT polymer are well mixed and that the flame retardant meltable phosphinate metal salt is not dispersed in the PTT polymer as a particulate during the mixing process. The flame retardant is selected so that the flame retardant meltable phosphinate metal salt comprises at least 10 wt. % of the flame retardant, and the amount of flame retardant is selected so 1) the meltable phosphinate metal salt comprises from 0.25 wt. % to 5 wt. % of the mixture and 2) the fiber has a tenacity of at least lg/d upon passing the mixture through the spinneret to form the fiber.

The flame retardant meltable phosphinate metal salt of the flame retardant used in the process of the present invention may be any phosphinate metal salt having the structure shown in formula (I) and having a melting point equal to or below 280° C., or below 270° C., or below 250° C., or below 230° C., or below 200° C., or below 180° C.

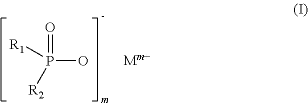

In formula (I), R₁ and R₂ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4. The flame retardant meltable phosphinate metal salt must have a melting point equal to or below 280° C., or below 270° C., or below 250° C., or below 230° C., or below 200° C., or below 180° C. so that it may be melted and dispersed in the PTT polymer at a temperature that will not substantially degrade the polymer.

In a preferred embodiment, the flame retardant meltable phosphinate metal salt used in the process of the present invention is a zinc phosphinate having a melting point equal to or below 280° C., or below 270° C., or below 250° C., or below 230° C., or below 200° C., or below 180° C. and having the structure of formula (I) where R₁ and R₂ are identical or different and are hydrogen, C₁-C₁₈ alkyl, linear or branched, and/or aryl, M is zinc, and m is 2. In one embodiment the zinc phosphinate has a melting point of equal to or below 280° C., or below 270° C., or below 250° C., or below 230° C., or below 200° C., or below 180° C. and is of the formula (I), where R₁ and R₂ are identical or different and are methyl, ethyl, isopropyl, n-propyl, t-butyl, n-butyl, or phenyl, M is zinc, and m is 2. In a preferred embodiment, the zinc phosphinate is selected from the group consisting of zinc diethylphosphinate, zinc dimethylphospinate, zinc methylethylphosphinate, zinc diphenylphosphinate, zinc ethylbutylphosphinate, and zinc dibutylphosphinate. In most preferred embodiment, the zinc phosphinate is zinc diethylphosphinate.

The amount flame retardant selected for use in the process is such that the flame retardant meltable phosphinate metal salt is present in an amount of from 0.25 wt. % to 5 wt. % of the mixture of the flame retardant and PTT polymer, and may be present in an amount of from 0.3 wt. % to 4 wt. %, or from 0.5 wt. % to 2.5 wt. % of the mixture. The flame retardant meltable phosphinate metal salt comprises at least 10 wt. % of the flame retardant, or may comprise greater than 50 wt. % of the flame retardant, or may comprise at least 75 wt. % of the flame retardant, or the flame retardant may consist essentially of the phosphinate metal salt.

The flame retardant utilized in the process of the invention may contain a flame retardant that is not a phosphinate metal salt having a melting point of equal to or below 280° C., which, as noted above, is defined for purposes of the present invention as the “non-fusible flame retardant component”. The non-fusible flame retardant component of the flame retardant, if present, does not have a melting point equal to or below 280° C., although the non-fusible flame retardant component may, but does not necessarily, have a melting point above 280° C. since the non-fusible flame retardant component may decompose rather than melt. Such non-fusible flame retardants may include phosphinate metal salts of the formula (I) that do not melt below a temperature of 280° C. such as calcium diethylphosphinate, other phosphorous containing compounds that are non-fusible at a temperature of below 280° C., including inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphoric, and phosphonic acids, diphosphinic salts, and nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate. Melamine cyanurate is a preferred non-fusible flame retardant used in the flame retardant in the process of the present invention.

In an embodiment of the process of the present invention, the flame retardant may be selected to contain less than 90 wt. %, or 50 wt. %, or less than 35 wt. %, or less than 25 wt. %, or less than 10 wt. %, or 5 wt. % of the non-fusible flame retardant component, or may be selected to contain no non-fusible flame retardant component. If present, the non-fusible flame retardant component of the flame retardant may be particulate. In an embodiment of the process of the present invention, the mean particle size of the non-fusible flame retardant component of the flame retardant may be selected to be 10 μm or less, or at most 3 μm, or may be selected to be nanoparticles having a mean particle size of less than 1μ. A smaller mean particle size of the non-fusible flame retardant provides at least two benefits in the process: 1) more homogeneous dispersion of the particulate flame retardant in the PTT polymer while mixing the flame retardant and the PTT polymer, resulting in better flame retardancy in the mixture and ultimately in the fiber spun from the mixture; and 2) reduced fiber breakage due to large particulates as the mixture of PTT polymer and flame retardant is melt spun into a fiber. In an embodiment of the process, the non-fusible flame retardant component of the flame retardant is selected to contain melamine cyanurate having a mean particle size of at most 3 μm.

The amount of flame retardant mixed with the PTT polymer in the process of the present invention is selected to 1) provide sufficient flame retardancy to the fiber spun from the mixture and 2) to ensure that the fiber spun from the mixture has sufficient tenacity to be used subsequently in the production of yarns, textiles, carpets, or non-woven materials, which is at least 1 g/d. To provide the mixture and resulting fiber with sufficient flame retardancy, the amount of flame retardant mixed with the PTT polymer is selected so the flame retardant meltable phosphinate metal salt comprises from 0.25 wt. %

to 5 wt. % of the mixture of flame retardant and PTT polymer, or from 0.3 wt. % to 4 wt. % of the mixture, or from 0.5 wt. % to 2.5 wt. % of the mixture.

The amount of flame retardant selected to be mixed with the PTT polymer to provide a mixture that may be spun into a fiber having a tenacity of at least 1 g/d is dependent on the amount of meltable phosphinate metal salt in the flame retardant, the intrinsic viscosity of the PTT polymer (or, if the flame retardant is mixed with the PTT polymer while the PTT polymer is being polymerized, the conditions under which the PTT polymer is polymerized), and, if present, the quantity and size of a particulate non-fusible flame retardant component in the flame retardant. Mixing the flame retardant comprising the flame retardant meltable phosphinate metal salt with the PTT polymer may reduce the intrinsic viscosity of the polymer, and, therefore, the tenacity of a fiber spun from the mixture relative to a fiber spun from the PTT polymer absent the flame retardant. In general, as the concentration of meltable phosphinate metal salt in the mixture increases the intrinsic viscosity of the mixture and the tenacity of a fiber spun from the mixture decreases, and, conversely, as the amount of meltable phosphinate metal salt decreases the intrinsic viscosity of the mixture and the tenacity of a fiber spun from the mixture increases. The concentration of the meltable phosphinate metal salt in the mixture may be increased by increasing the proportion of the meltable phosphinate metal salt in the flame retardant and/or increasing the amount of flame retardant in the mixture Likewise, the concentration of the meltable phosphinate metal salt in the mixture may be decreased by decreasing the proportion of meltable phosphinate metal salt in the flame retardant and/or by decreasing the amount of flame retardant in the mixture. The appropriate amount of flame retardant to mix with the PTT polymer to produce a mixture that may be spun into a fiber having a tenacity of at least 1 g/d may be determined without undue experimentation by determining the intrinsic viscosity of the PTT polymer and determining the amount of meltable phosphinate metal salt and the amount of a non-fusible flame retardant component in the flame retardant, and adjusting the amount of flame retardant mixed in the PTT polymer or the relative amounts of meltable phosphinate metal salt and non-fusible flame retardant component in the flame retardant as necessary to provide a mixture that may be spun into a fiber having a tenacity of 1 g/d or greater.

To provide a mixture that may be spun into a fiber having a tenacity of at least 1 g/d, the relative amount of flame retardant to the PTT polymer may be selected so that the amount of flame retardant meltable metal phosphinate salt in the mixture of the flame retardant and PTT polymer is from 0.25 wt. % to 5 wt. % of the mixture and the mixture has an intrinsic viscosity of at least 0.7 dl/g, or at least 0.8 dl/g, or at least 0.9 dl/g. In an embodiment, the amount of flame retardant relative to the PTT polymer may be selected so that the flame retardant may be from 0.25 wt. % to 15 wt. %, or from 0.5 wt. % to 10 wt. %, or from 1 wt. % to 5 wt. % of the mixture and the amount of meltable phosphinate metal salt in the mixture is at least 0.25 wt. % and not more than 4 wt. %, or not more than 3 wt. %, or not more than 2.5 wt. %, or not more than 2 wt. %, or not more than 1 wt. %, and the mixture has an intrinsic viscosity of at least 0.7 dl/g, or at least 0.8 dl/g, or at least 0.9 dl/g. The intrinsic viscosity of the PTT polymer and the mixture of the flame retardant and the PTT polymer may be measured by dissolving the polymer in a solvent of phenol and 1,1,2,2-tetrachloroethane (60 parts phenol, by volume, 40 parts 1,1,2,2-tetrachloroethane, by volume) and measuring at 30° C. the intrinsic viscosity of the dissolved polymer on a relative viscometer, preferably Model No. Y501B available from Viscotek Company.

If the flame retardant contains a particulate non-fusible flame retardant component, the amount of flame retardant to be mixed with the PTT polymer may be selected so the fiber has a tenacity of at least 1 g/d, where the amount of non-fusible flame retardant component is limited to ensure that the fiber has a tenacity of at least 1 g/d. Excessive particulates, especially particulates having a mean particle diameter of greater than 10 μm, may weaken the fiber spun from the mixture. In an embodiment, the amount of flame retardant containing a particulate non-fusible flame retardant component is selected so that the particulate non-fusible flame retardant component comprises at most 15 wt. % of the mixture of flame retardant and PTT polymer, or at most 10 wt. % of the mixture, or at most 5 wt. % of the mixture, or at most 2.5 wt. % of the mixture.

In an embodiment of the process of the invention, the flame retardant may be selected so that one or more flame retardant meltable phosphinate metal salts comprise at least 50 wt. % of the flame retardant, and the amount of flame retardant mixed with the PTT polymer to form the mixture is selected so that the weight ratio of the flame retardant to the PTT polymer in the mixture is in the range from 1:400 up to, but not including, 1:10, or from 1:100 to 1:20, or from 1:50 to 1:25, where the mixture has an intrinsic viscosity of at least 0.7 dl/g, or at least 0.8 dl/g, or at least 0.9 dl/g and a fiber spun from the mixture has a tenacity of at least 1 g/d, or at least 1.2 g/d, or at least 1.3 g/d, or at least 1.5 g/d. In another embodiment of the process of the invention, the flame retardant may be selected so that one or more meltable phosphinate metal salts comprise from 10 wt. % to 50 wt. % of the flame retardant, and the amount of flame retardant mixed with the PTT polymer to form the mixture is selected so that the weight ratio of the flame retardant to PTT polymer in the mixture is in the range from 1:200 up to, but not including, 1:1, or from 1:100 to 1:5, or from 1:50 to 1:10, where the mixture has an intrinsic viscosity of at least 0.7 dl/g, or at least 0.8 dl/g, or at least 0.9 dl/g and a fiber spun from the mixture has a tenacity of at least 1 g/d, or at least 1.2 g/d, or at least 1.3 g/d, or at least 1.5 g/d.

The flame retardant may be mixed with the PTT polymer at a temperature of from 180° C. to 280° C. either in the polymerization process of forming the PTT polymer or after the PTT polymer has been formed by polymerization. The temperature at which the flame retardant and the PTT polymer are mixed should be selected to be above the melting point of the PTT polymer and the meltable phosphinate metal salt of the flame retardant.

In an embodiment of the process of the present invention, the flame retardant is mixed with 1,3-propanediol (“PDO”), terephthalic acid (“TPA”), PTT polymer, and, optionally, non-PTT co-monomers in the process of producing the PTT polymer to form the mixture that is subsequently passed through a spinneret to form the fiber. The PTT polymer can be made by the esterification of PDO with TPA followed by optional prepolycondensation of the reaction product and polycondensation, preferably with a mole excess of PDO and, also preferably, wherein the reaction conditions include maintenance of relatively low concentrations of PDO and TPA in the melt reaction mixture. Polymerization of PTT from PDO and TPA may be performed in a continuous process or a batch process.

In the esterification step, the instantaneous concentration of unreacted PDO in the reaction mass may be maintained relatively low to obtain high intrinsic viscosity PTT polymer. This is accomplished by regulation of pressure and monomer feed. PDO and TPA may be fed to a reaction vessel in a total feed molar ratio within the range of about 1.1:1 to about 3:1. The PDO:TPA feed ratio may be from about 1.1:1 to 1.5:1 to minimize the amount of acrolein byproduct produced. The PDO and TPA may be added gradually so as to allow time to allow the conversion to ester to take place and keep the PDO and TPA concentrations low.

Also, to maintain the desired instantaneous concentration of PDO in the esterification step, a relatively low reaction pressure may be maintained, although the esterfication step may be conducted at pressures greater than atmospheric. The pressure in a low pressure esterification step may be maintained below 0.3 MPa absolute, generally within the range of about 0.07 to about 0.15 MPa absolute. The temperature of the esterification step may be from 240° C. to 270° C. The time of the esterification step may range from 1 hour to 4 hours.

An esterification catalyst is optional in an amount of from 5 parts per million (ppm) to 100 ppm (metal), or from 5 ppm to 50 ppm, based on the weight of the final polymer. The esterification catalyst may be of relatively high activity and resistant to deactivation by the water byproduct of the esterification step. Such esterification catalysts include titanium and zirconium compounds, including titanium alkoxides and derivatives thereof, such as tetra(2-ethylhexyl)titanate, tetrastearyl titanate, diisopropoxy bis(acetylacetonato)titanium, di-n-butoxy-bis(triethanolaminoato)titanium, tributylmonoacetyl titanate, and tetrabenzoic acid titanate; titanium complex salts such as alkyl titanium oxalates and malonates, potassium hexafluoro titantate and titanium and titanium complexes with hydroxy carboxylic acids such as tartaric acid, citric acid, or lactic acid, catalysts such as titanium dioxide/silicon dioxide coprecipitate, and hydrated alkaline-containing titanium dioxide; and the corresponding zirconium compounds. Catalysts of other metals, such as antimony, tin, zinc, and the like can also be used. A catalyst useful for both esterification and polycondensation steps in preparing the PTT polymer is titanium tetrabutoxide.

Non-PTT co-monomers may be included in the esterification step. Non-PTT co-monomers include, but are not limited to, ethylene glycol, 1,4-butanediol, 1,4-cyclohexanedimethanol, oxalic acid, succinic acid, phthalic acid, 2,6-naphthalenedicarboxylic acid, 5-sodiumsulfoisophthalic acid, isophthalic acid, and/or adipic acid.

A precondensation (prepolymerization) step is optional in the process of producing PTT polymer from PDO and TPA, but is useful to obtain a high intrinsic viscosity PTT polymer. If such a step is carried out, the pressure on the esterification product mixture is reduced to less than 0.02 MPa and the temperature is maintained within the range of 250° C. to 270° C., and the precondensation may be effected in less than 2 hours. The precondensation step, particularly in a continuous process, may be carried out in two vacuum stages, where the pressure is decreased in the second stage. Non-PTT co-monomers may be added in the precondensation step for inclusion in the PTT polymer, and include the non-PTT co-monomers described above.

In the polycondensation (or polymerization) step of the process, the reactants may be maintained under vacuum at a pressure of from 2 to 25 Pa, and a temperature of from 245° C. to 270° C. for a period of from 1 to 6 hours until a PTT polymer is obtained having an intrinsic viscosity of from 0.7 dl/g to 1.5 dl/g. The polycondensation step is suitably carried out in a high surface area generation reactor capable of large vapor mass transfer such as a cage-type basket, perforated disc, disc ring, or twin screw reactor. The polycondensation may be carried out in the presence of a metal polycondensation catalyst, such as the titanium compounds described above. Titanium butoxide is an effective polycondensation catalyst for producing PTT polymer, and may be used in amounts of from 25 ppm to 100 ppm titanium Non-PTT co-monomers may be added in the polycondensation step for inclusion in the PTT polymer, and include the non-PTT co-monomers described above.

Non-PTT co-monomers added for inclusion in the PTT polymer at the esterification, pre-polycondensation, and/or polycondensation steps may be added in an amount to provide a molar ratio of non-PTT co-monomer to the PTT co-monomer diol or acid which the non-PTT co-monomer is intended to replace in the polymer chain of at most 1:4 so that the PTT polymer contains at least 75 mol % trimethylene terephalate units in the polymer chain. In an embodiment, the non-PTT co-monomers may be added in an amount effective to provide a molar ratio of non-PTT co-monomer to the PTT co-monomer diol or acid which the non-PTT co-monomer is intended to replace in the polymer chain of at most 1:10. In another embodiment, no non-PTT co-monomers are added in the production of the PTT polymer so that the PTT polymer is a PTT homopolymer.

To form the flame retardant/PTT polymer mixture, the flame retardant containing the flame retardant meltable phosphinate metal salt may be added in the process for producing PTT polymer from PDO and TPA at the beginning of the process—such as being mixed with one or both of the feed reactants or added independently—during the process—such as in the esterification stage or in the optional prepolycondensation stage or in the polycondensation stage—or after polycondensation while PTT is still in molten form. The flame retardant may be contacted with the PTT polymer to create the flame retardant/PTT polymer mixture as the PTT polymer is formed, for example in the esterification, pre-polycondensation, or polycondensation stage, or after the PTT polymer is formed, for example after polycondensation while PTT is still in molten form.

The flame retardant is contacted with the PTT polymer at a temperature from 180° C. to 280° C. where the temperature is selected to be above the melting point of the PTT polymer and the flame retardant meltable phosphinate metal salt of the flame retardant. Preferably the flame retardant and the PTT polymer are well mixed when contacted at a temperature above the melting point of the PTT polymer and the flame retardant meltable phosphinate metal salt of the flame retardant so as to provide a homogeneous dispersion of the flame retardant in the PTT polymer.

In another embodiment, the flame retardant may be contacted with 1,3-propanediol (“PDO”), dimethylterephthalate(“DMT”), and PTT polymer in the process of producing the PTT polymer to form the mixture that is subsequently passed through a spinneret to form the fiber. PTT polymer can be made by the transesterification of PDO with DMT followed by optional prepolycondensation of the reaction product and polycondensation, preferably with a mole excess of PDO and, also preferably, wherein the reaction conditions include maintenance of relatively low concentrations of PDO and DMT in the melt reaction mixture. Polymerization of PTT from PDO and DMT may be performed in a continuous process or a batch process.

The process steps for producing PTT polymer from PDO and DMT are similar to those described above for producing PTT polymer from PDO and TPA except that DMT is substituted for TPA in the process. Non-PTT co-monomers may be added in the process as described above with respect to producing PTT polymer from PDO and TPA. To form the flame retardant/PTT polymer mixture, the flame retardant containing the flame retardant meltable phosphinate metal salt may be added to the process for producing PTT polymer from PDO and DMT at the beginning of the process—such as being mixed with one or both of the feed reactants or added independently—during the process—such as in the transesterification stage or in the optional prepolycondensation stage or in the polycondensation stage—or after polycondensation while PTT is still in molten form as described above with respect to contacting the flame retardant with PTT polymer formed by polymerizing PDO and TPA. The flame retardant is contacted with the PTT polymer at a temperature above the melting point of the PTT polymer and the flame retardant meltable phosphinate metal salt of the flame retardant, also as described above.

In another embodiment, the flame retardant comprising the flame retardant meltable phosphinate metal salt may be contacted with PTT polymer after the polymerization process to form the mixture that is subsequently passed through a spinneret to form the fiber. For example, the flame retardant may be contacted with a pelletized solid PTT polymer and then heated to a temperature above the melting point of the PTT polymer and the flame retardant. In another embodiment, the flame retardant may be contacted with molten PTT polymer after a solid PTT polymer is heated to above the melting point of the PTT polymer. In either case, the flame retardant is contacted with the PTT polymer at a temperature above the melting point of the PTT polymer and above the melting point of the flame retardant meltable phosphinate metal salt of the flame retardant.

In an embodiment of the process of the present invention, a supplementary polymer may be contacted with the PTT polymer and the flame retardant at a temperature of from 180° C. to 280° C. where the temperature is selected so that flame retardant meltable phosphinate metal salt, the PTT polymer, and the supplementary polymer each have a melting point below the selected temperature. The supplementary polymer may form up to 25 wt. % , or up to 15 wt. %, or up to 10 wt. %, or up to 5 wt. % of the mixture of flame retardant, PTT polymer, and supplementary polymer. In one embodiment, the supplementary polymer is selected from the group consisting of polyamides and polyesters. The supplementary polymer may be NYLON-6, NYLON-6,6, poly(ethylene terephthalate), poly(butylene terephthalate), poly(ethylene naphthalate), poly(trimethylene naphthalate), or mixtures thereof. In an embodiment, the supplementary polymer is NYLON-6 or NYLON-6,6 which is contacted with the flame retardant and the PTT polymer to form a flame retardant PTT mixture having increased viscosity relative to the flame retardant PTT polymer without the inclusion of the supplementary polymer, and which may be spun into a fiber having increased tenacity relative to a fiber spun from the flame retardant PTT polymer without inclusion of the supplementary polymer.

In another embodiment of the process of the present invention, a mixture of the flame retardant comprising the flame retardant meltable phosphinate metal salt and a polymer is prepared as a master batch, and the master batch is mixed with a PTT polymer containing from 0 wt. % to less than 4.5 wt. % of a meltable phosphinate metal salt to prepare the mixture that is passed through a spinneret to form a fiber having a tenacity of at least 1 g/d. The master batch of polymer and flame retardant may be prepared as described above with respect to forming a mixture of PTT polymer and a flame retardant comprising a meltable phosphinate metal salt having a melting point equal to or below 280° C., except the master batch may contain an amount of flame retardant effective to provide from 1 wt. % to 40 wt. %, or from 2 wt. % to 30 wt. % of the flame retardant meltable phosphinate metal salt, and the master batch may be formed of a polymer other than PTT polymer. The molten master batch of flame retardant polymer may or may not have an intrinsic viscosity of at least 0.7 dl/g.

The master batch of flame retardant containing polymer may be mixed with a PTT polymer containing from 0 wt. % to less than 4.5 wt. % of a meltable phosphinate metal salt, preferably containing no meltable phosphinate metal salt, to form the mixture to be passed through a spinneret to form a flame retardant fiber. The master batch is mixed with the PTT polymer at a temperature from 180° C. to 280° C. which is selected to be above the melting points of the flame retardant meltable phosphinate metal salt of the master batch, the meltable phosphinate metal salt of the PTT polymer with from 0 wt. % to less than 4.5 wt. % meltable phosphinate metal salt, if any, the polymer of the master batch, and the PTT polymer containing from 0 wt. % to less than 4.5 wt. % of a meltable phosphinate metal salt. The molten master batch may be mixed with the PTT polymer in quantities effective to provide a mixture containing from 0.25 wt. % to 5 wt. % of one or more flame retardant meltable phosphinate metal salts and having an intrinsic viscosity of at least 0.7 dl/g.

In one embodiment of the process of the present invention, the polymer used to initially form the master batch is a PTT polymer containing at least 75 wt. % PTT polymer that is comprised of at least 75 mol % trimethylene terephthalate. In another embodiment, the polymer used to initially form the master batch is selected from the group consisting of polyamides, polyesters other the PTT, PTT co-polymers, and mixtures thereof. If a polymer other than a PTT polymer is used as the master batch polymer, at most 25 wt. % of the master batch polymer may be mixed with the PTT polymer to form the mixture to be passed through a spinneret to form the fiber

In another embodiment of the process of the invention, the PTT polymer and the flame retardant are mixed as described above without the addition of a filler to form a mixture containing no filler. The mixture containing no filler may be passed through a spinneret to form a fiber containing no filler and having a tenacity of at least 1 g/d. In another embodiment, the PTT polymer and the flame retardant are mixed as described above, where a filler is mixed with the PTT polymer and flame retardant in the mixture, where the amount of filler is selected to be from 0.1 wt% to 10 wt. %, or from 0.2 wt. % to 5 wt. % of the mixture. The mixture containing the filler may then be passed through a spinneret to form a fiber having a tenacity of at least 1 g/d. In one embodiment, titanium dioxide is selected as the filler, where the titanium dioxide is used as a delusterant.

In a preferred embodiment, the flame retardant comprising the flame retardant meltable phosphinate metal salt and a PTT polymer containing at least 75 mol % trimethylene terephthalate are contacted, heated, and mixed together to form the mixture for passing through a spinneret in an extruder at a temperature above the melting point of the PTT polymer and above the melting point of the flame retardant meltable phosphinate metal salt of the flame retardant to produce the flame retardant PTT containing polymer. Alternatively, a previously formed mixture of the flame retardant and PTT polymer formed as described above is heated and mixed in an extruder at a temperature above the melting point of the PTT polymer and above the melting point of the flame retardant meltable phosphinate metal salt of the flame retardant for passing through a spinneret. Alternatively, a quantity of a molten master batch mixture of flame retardant polymer may be added to and blended with a PTT polymer in an extruder at a temperature effective to melt and blend the PTT polymer and the master batch mixture of flame retardant polymer, where the blend may be passed through a spinneret from the extruder.

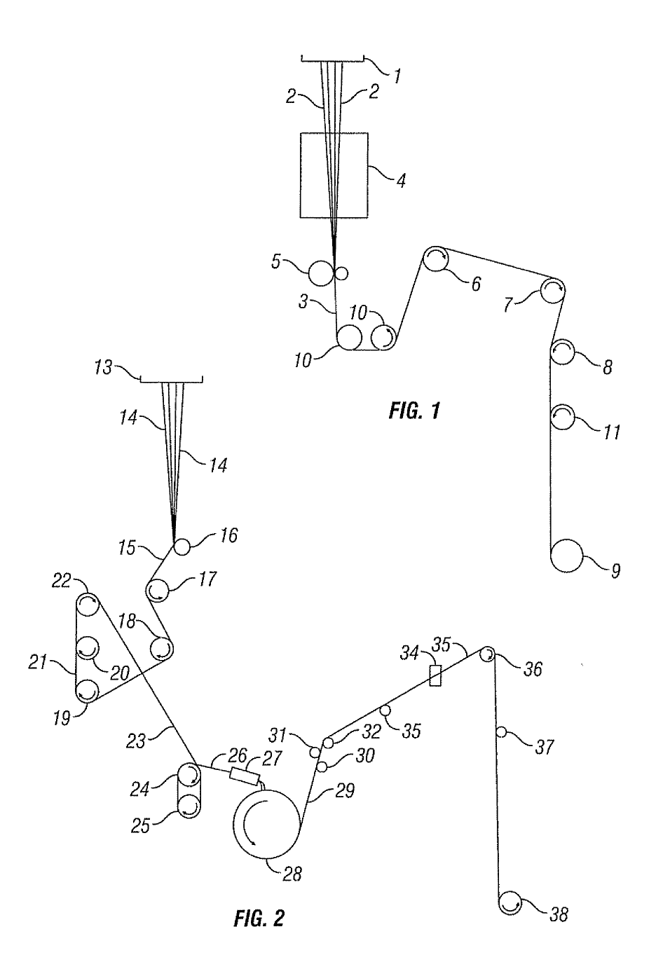

In an embodiment of the process of the invention, the mixture of the flame retardant comprising the flame retardant meltable phosphinate metal salt and the PTT polymer, however formed, may be formed into a fully oriented yarn, a partially oriented yarn, or an undrawn yarn useful in textile or carpet applications. Referring now to FIG. 1, the mixture or blend of the flame retardant and PTT polymer may be melt blended in extruder at a temperature of from 180° C. to 280° C., preferably from 240° C. to 280° C., where the temperature is selected to be above the melting point of the PTT polymer and the flame retardant meltable phosphinate metal salt component of the flame retardant. The melt blended flame retardant and PTT polymer may then be passed through a spinneret 1 located at the extruder outlet into a plurality of melt spun continuous filaments 2. The die holes in the spinneret 1 may have a size and shape selected to provide desired characteristics to a yarn 3 formed of a plurality of the filaments 2. Multiple spinnerets (not shown) may be coupled to the extruder to enable multiple yarns to be spun simultaneously from the flame retardant PTT polymer mixture.

The filaments 2 may be rapidly cooled and converged into a multifilament yarn 3. The filaments 2 may be cooled by contacting the filaments 2 with cold air, preferably by blowing cold air over the filaments 2. In one embodiment, the filaments 2 may pass through a quench air box or cylinder 4 surrounding the filaments which defines a cold air zone. The cold air may be directed inward from the interior surface of the quench air box or cylinder 4 to cool the filaments 2.

The multi-filament yarn 3 may be passed through a spin finish applicator 5, shown in FIG. 1 as an oiling roll, to apply a finishing agent on the yarn 3. The finishing agent is preferably an oil agent containing a fatty acid ester and/or mineral oil, or a polyether.

The multi-filament flame retardant PTT yarn 3 may then be processed into a fully drawn yarn, a partially oriented yarn, or an undrawn yarn.

If the yarn 3 is to be a fully oriented yarn, the yarn 3 may be drawn in a one or two-stage drawing process over feed 6 and drawing rolls 7 and 8 prior to being taken up by a take-up mechanism 9, where the feed 6 and drawing rolls 7 and 8 may include at least one heated roll and the relative speeds of the feed 6 and drawing rolls 7 and 8 and take-up mechanism 9 may be set to produce a fully oriented yarn. For example, a fully drawn yarn may be produced by drawing the yarn 3 at a first draw ratio of from 1.01 to 2, and the temperatures of the feed roller 6 and draw rollers 7 and 8 are controlled so the feed roller 6 is operated at a temperature of less than 100° C. and the draw rollers 7 and 8 are operated at temperatures of greater than the temperature of the feed roller 6 and within the range of 50° C. to 150° C. The first draw ratio may be controlled by controlling the speeds of the feed roller 6 relative to the draw roller 7, for example, the feed roller 6 may rotate at a speed of 1000 m/min and the draw roller 7 may have a speed of 1050 m/min The yarn is subsequently drawn at a second draw ratio of at least 2.2 times that of the first draw ratio where the draw roller 8 is heated to a temperature greater than the draw roller 7 and within the range of from 100° C. to 200° C. The second draw ratio may be controlled by controlling the speeds of the draw roller 8 relative to the draw roller 7, for example, the draw roller 8 may have a speed of 3000 m/min and the draw roller 7 may have a speed of 1050 m/min The drawn yarn may subsequently be wound with the take-up mechanism 9. Denier control rolls 10 and an optional relax roller 11 may be used to facilitate the yarn spinning process. The drawn yarn may be textured prior to or after winding in accordance with conventional yarn texturing processes.

If the yarn 3 is to be a partially oriented yarn, the yarn 3 may be either drawn in a one or two stage process over feed 6 and drawing rolls 7 and 8 prior to being taken up by a take-up mechanism 9, or the yarn may be directly taken-up by the take-up mechanism 9. If the partially oriented yarn is produced by drawing prior to being taken up by a take-up mechanism, the draw ratio is less than that used to produce a fully oriented yarn, as described above, resulting in only partial longitudinal orientation of the polymer molecules. For example, the yarn 3 may be heated above the glass transition temperature of the yarn, e.g. at least 45° C. or at least 60° C., and drawn at a draw ratio of 0.7 to 1.3 in a single stage draw process where the feed roll 6 is operated at a speed of from 1800 to 3500 m/min and the draw rolls 7 and 8 are operated at the same speed of from 1250 m/min to 4550 m/min, where the relative speed of the draw rolls 7 and 8 to the feed roll 6 determines the draw ratio. If the partially oriented yarn is produced by being directly taken up by the take-up mechanism 9, the take-up mechanism 9 is operated at a speed effective to induce partial orientation in the yarn. For example, the take-up mechanism 9 may operate at a speed of 3500 to 4500 m/min or at a speed of from 2000 to 2600 m/min to induce partial orientation in the yarn while winding the yarn. The partially oriented yarn may be wound onto a yarn package, and may be subsequently textured.

If the yarn 3 is to be an undrawn yarn, the yarn may be directly taken up by the take-up mechanism 9 at a speed that does not induce longitudinal orientation of the polymer molecules in the yarn fiber. For example, the take-up mechanism 9 may operate at a speed of from 500 m/min to 1500 m/min to produce an undrawn yarn. The undrawn yarn may be subsequently stored in a tow can, textured, drawn, and cut into staple fibers.

The textured fully oriented yarn, textured partially oriented yarn, and textured undrawn yarn may be utilized to produce textiles or carpets in accordance with known conventional techniques for forming textiles or carpets from fully oriented, partially oriented, or undrawn yarns.

In another embodiment, as shown in FIG. 2, extruded filaments of the flame retardant PTT polymer may be formed into bulk continuous filaments particularly useful for forming carpets. A mixture containing molten PTT polymer and the flame retardant, including molten flame retardant meltable phosphinate metal salt, may be passed through a spinneret 13 into a plurality of continuous filaments 14, at a temperature of from 180° C. to 280° C., preferably from 240° C. to 280° C., where the temperature is selected so the temperature is above the melting point of the PTT polymer and the flame retardant meltable phosphinate metal salt of the flame retardant. The filaments 14 may be rapidly cooled, preferably by contact with cold air, and converged into a multifilament yarn 15. The multifilament yarn 15 may be contacted with a spin finish applicator 16 to apply a finishing agent on the yarn 15. The finishing agent is preferably an oil agent containing a fatty acid ester and/or mineral oil, or a polyether.

The multifilament yarn 15 may be fed to a first drawing stage by control rolls 17 and 18. The first drawing stage is defined by feed roll 19 and a draw roll 20. Between rolls 19 and 20, yarn 21 may drawn at a relatively low draw ratio, within the range of 1.01 to 2 and preferably within the range of 1.01 to 1.35, where the draw ratio is controlled by selecting the speed of the rolls 19 and 20. The temperature of the feed roll 19 is kept low, where preferably the feed roll 19 is unheated, but at most the temperature of the feed roll 19 is from 30° C. to 80° C. The draw roll 20 may be heated to a temperature of from 50° C. to 150° C., preferably about 90° C. to 140° C., to facilitate drawing the yarn 21 without breaking the yarn.

The drawn yarn 21 may be passed to a second drawing stage defined by draw rolls 20 and 22. The second stage draw may be carried out at a relatively high draw ratio with respect to the first stage draw ratio, generally at least 2.2 times that of the first stage draw ratio, preferably at a draw ratio within the range of 2.2 to 3.4 times of that of the first stage. Draw roll 22 may be maintained at a temperature in the range of 100 to 200° C. In general, the three rollers 18, 19, and 22 will be sequentially higher in temperature.

Drawn yarn 23 may be passed to heated rolls 24 and 25 to preheat the drawn yarn 23 prior to texturing. The heated drawn yarn 26 may then be texturized by passing the yarn 26 through a texturing air jet 27 for bulk enhancement of the yarn 26, and then to a jet cooling drum 28. The bulk textured yarn 29 may then be passed through tension controls 30, 31, and 32 and through idler 33 to an optional entangler 34 for yarn entanglement. Entangled yarn 35 may be advanced by idler 36 to an optional spin finish applicator 37 and then is wound onto winder 38. The bulk continuous filament yarn can then be processed by twisting, texturing, and heat-setting as desired and tufted into carpet according to conventional methods.

In another aspect, the present invention is directed to a material comprising a plurality of fibers wherein at least 5% of the fibers are comprised of (a) a polymer comprised of at least 75 wt. % poly(trimethylene terephthalate) comprised of at least 75 mol % trimethylene terephthalate; and (b) a flame retardant comprising a flame retardant phosphinate metal salt having a melting point equal to or below 280° C., or below 270° C., or below 250° C., or below 230° C., or below 200° C., or below 180° C.; wherein the phosphinate metal salt comprises from 0.25 wt. % to 5 wt. %, or from 0.3 wt. % to 4 wt. %, or from 0.5 wt. % to 2.5 wt. % of the flame retardant PTT polymer fibers and wherein the phosphinate metal salt comprises at least 10 wt. % of the flame retardant of the flame retardant PTT polymer fibers. The fibers comprised of PTT polymer and the flame retardant preferably have a tenacity of at least 1 g/d. The PTT polymer in the flame retardant PTT polymer fibers is a PTT polymer as described above. The flame retardant meltable phosphinate metal salt may be a phosphinate metal salt having the formula (I) above and/or its polymers where R₁ and R₂ are identical or different and are hydrogen, C₁-C₁₈ alkyl, linear or branched, and/or aryl, M is Mg, Ca, Al, Sb, Ge, Ti, Fe, Zr, Ce, Bi, Sr, Mn, Li, Na, or K, and m is 1 to 4. Preferably M is zinc and m is 2. Most preferably, the flame retardant meltable phosphinate metal salt is zinc diethyl phosphinate. Such flame retardant PTT polymer fibers and processes for producing them are described above.

In an embodiment, the material is a carpet. Preferably the carpet contains at least 50%, or at least 75%, or at least 90%, of the flame retardant PTT polymer fibers. Most preferably, the flame retardant meltable phosphinate salt in the flame retardant PTT polymer carpet fibers is zinc diethylphosphinate. The carpet may be prepared with the flame retardant PTT polymer fibers in accordance with conventional methods for producing carpets from synthetic polymer fibers. In a preferred embodiment, the flame retardant PTT polymer fiber used to produce the carpet is a bulk continuous filament fiber.

The carpet of the present invention is a PTT fiber based carpet that may be more surface flame resistant than conventional PTT fiber based carpets. The carpet of the present invention may have sufficient flame resistance to pass a small-scale ignition test, in particular the “pill test” as described in 16 C.F.R. §1630 (§1630.1-1630.4) (1-1-06 Edition) or a comparable test with at least a 90% pass rate, or at least a 95% pass rate. Specifically, the carpet of the present invention has a flame resistance such that the probability that a methanamine tablet ignited on the carpet in a pill test will char the carpet a distance of at most 7.62 cm (3 in.) from the tablet is at least 90% or at least 95%.

The “pill test” as provided in 16 C.F.R. §1630 (1-1-06 Edition) or a comparable test, for purposes of the present invention, includes the following steps and criteria. A sample of carpet that includes a circular area having a diameter greater than 20.32 cm (8 in.), more preferably having a diameter of 22.86±0.64 cm (9±¼ in.) is provided. For purposes of the present invention the sample may be any shape, e.g. square or circular, but the sample must include a circular area having a diameter of at least 20.32 cm—the C.F.R. test requires a square sample having 22.86±0.64 cm sides. The sample may be washed and dried 10 times using a wash temperature of 60°±3° C. and a tumble dry exhaust temperature of 66°±5° C. (washing and drying is required in the CFR test, but is not necessary for a test in accordance with the present invention). The sample is cleaned until it is free of loose ends and any material that may have worked into the pile during handling, preferably with a vacuum cleaner. The sample is placed in a drying oven in a manner to permit free circulation of air at 105° C. around the sample for 2 hours, and then is placed in a dessicator with the carpet traffic surface up until cooled to room temperature, but no less than 1 hour. The sample is then removed from the dessicator and brushed with a gloved hand to raise the pile of the sample. The sample is placed horizontally flat in a test chamber and a metal plate flattening frame having 20.32 cm (8 in.) diameter hole in its center is centered and placed on top of the sample (preferably the metal plate is a 22.86 cm×22.86 cm (9 in.×9 in.) steel plate with an 20.32 cm diameter hole therein). A methenamine tablet weighing approximately 0.149 gram is then placed on the sample in the center of the 20.32 cm hole in the flattening frame. The tablet is ignited by touching a lighted match or an equivalent lighting source to the top of the tablet. The test is continued until either the last vestige of flame or glow disappears or the flaming or smoldering has approached to within 2.54 cm (1 in.) of the edge of the hole in the flattening frame at any point. When all combustion has ceased the shortest distance between the edge of the hole in the flattening frame and the charred area is measured and recorded. A sample that passes the test is a sample in which the charred area is more than 2.54 cm (1 in.) from the edge of the hole in the flattening frame at any point (is charred less than or equal to 7.62 cm (3 in.) from the location of the pill).

The carpet of the present invention may also possess sufficient flame resistance to meet Class I or Class II categories of the flooring radiant panel test of the American Association of Testing and Materials ASTM-E-648, incorporated herein by reference. A sample meeting the Class I category has an average minimum radiant flux of 0.45 watts per square centimeter, and a sample meeting the Class II category has an average minimum radiant flux of 0.22 watts per square centimeter. The flooring radiant panel test ASTM-E-648 includes the following steps. A 100×20 cm (39 in×8 in.) carpet sample is horizontally mounted on the floor of a test chamber having an air/gas-fired radiant energy panel mounted above the specimen. The air/gas fired radiant energy panel is positioned to generate a maximum of approximately 1.1 watts per square centimeter of radiant energy immediately under the panel and a minimum of approximately 0.1 watts per square centimeter of radiant energy at the far end of the sample remote from the panel. A gas-fired pilot burner is used to initiate the flaming of the sample. The test is continued until the sample ceases to burn. The distance from the sample burns is measured and recorded. The radiant heat energy exposure at the point the sample “self-extinguished” is noted and is reported as the sample's critical radiant flux—which is the minimum energy needed to sustain flame propagation.

In another embodiment, the material is a textile. Preferably the textile contains at least 5%, or at least 10%, or at least 25%, or at least 50%, or at least 75%, or at least 90% of the flame retardant PTT polymer fibers. Most preferably, the flame retardant meltable phosphinate salt in the flame retardant PTT polymer textile fibers is zinc diethylphosphinate. The textile may be prepared with the flame retardant PTT polymer fibers in accordance with conventional methods for producing textile from synthetic polymer fibers. In an embodiment, the flame retardant PTT polymer fiber used to produce the textile is a fully oriented yarn or a partially oriented yarn. In an embodiment, the flame retardant PTT polymer fiber used to produce the textile is a staple fiber.

### EXAMPLE 1

A fiber composition of the present invention was made in accordance with the process of the present invention. A master batch of flame retardant poly(trimethylene terephthalate) was prepared by mixing and heating zinc diethylphosphinate having a melting point of 210° C.-215° C. and poly(trimethylene terephthalate) having a melting point of 225° C.-230° C. at a temperature of 245° C.-260° C. The amount of zinc diethylphosphinate (flame retardant) was selected so that the zinc diethylphosphinate comprised 20 wt. % of the master batch mixture. After preparation of the master batch of flame retardant poly(trimethylene terephthalate), the master batch of flame retardant poly (trimethylene terephthalate) and a poly(trimethylene terephthalate) polymer were heated and mixed in a extruder so that the master batch of flame retardant poly(trimethylene terephthalate) was present in an amount of 2.5 wt. % of the mixture of master batch flame retardant poly(trimethylene terephthalate) and poly(trimethylene terephthalate) polymer, and so the mixture contained 0.5 wt. % zinc diethylphosphinate (2.5 wt. % master batch flame retardant PTT in mixture×20 wt. % zinc diethylphosphinate in master batch mixture). The mixture was heated and mixed in the extruder, fed to a spin beam, and pumped through a spinneret by a spin pump in a temperature range from an initial temperature of 235° C. to a temperature of 257° C. The mixture was extruded through a spinneret having a 0.285 mm×0.95 mm×1 5 mm trilobal cross-section to form a poly(trimethylene terephthalate) filament containing 0.5 wt. % zinc diethylphosphinate. 68 of the filaments were combined to form a multi-filament fiber. The multi-filament fiber was drawn at ambient temperature between a first draw roll spinning at 1000 m/min and a second draw roll spinning at 1030 m/min, then was drawn a second time between the second draw roll spinning at 1030 m/min and a third draw roll spinning at 3000 m/min The drawn multi-filament fiber was then heat set at a temperature of 150° C., then heated to 170° C. and textured by exposure to high pressure air, cooled on a cooling drum, and wound. Properties of the fiber are provided in Table 1.

### EXAMPLE 2

A fiber composition of the present invention was made in accordance with the process of the present invention. The fiber composition was made in the manner described in Example 1 except the amount of the master batch flame retardant poly(trimethylene terephthalate) mixed with poly(trimethylene terephthalate) was such that the master batch flame retardant poly(trimethylene terephthalate) was present in the mixture at 5 wt. % and the zinc diethylphosphinate was present in the mixture at 1 wt. % (5 wt. % master batch flame retardant poly(trimethylene) terephthalate in mixture×20 wt. % zinc diethylphosphinate in master batch flame retardant poly(trimethylene terephthalate). Properties of the fiber are provided in Table 1.

### EXAMPLE 3

A fiber composition of the present invention was made in accordance with the process of the present invention. The fiber composition was made in the manner described in Example 2 except that the multi-filament fiber was drawn at ambient temperature between a first draw roll spinning at 1066 m/min and a second draw roll spinning at 1100 m/min, then was drawn a second time between the second draw roll spinning at 1100 m/min and a third draw roll spinning at 3200 m/min Properties of the fiber are provided in Table 1.

### EXAMPLE 4

A fiber composition of the present invention was made in accordance with the process of the present invention. The fiber composition was made in the manner described in Example 1 except that the master batch flame retardant poly(trimethylene terephthalate) was prepared by mixing and heating flame retardant components zinc diethylphosphinate and melamine cyanuarate (mean particle size about 3 μm) and poly(trimethylene terephthalate) so that the master batch mixture contained 15 wt. % zinc diethylphosphinate and 15 wt. % melamine cyanurate. Upon mixing the master batch flame retardant poly(trimethylene terephthalate) with the poly(trimethylene terephthalate) polymer, the mixture contained 0.375 wt. % zinc diethylphosphinate and 0.375 wt. % melamine cyanurate. Properties of the fiber are provided in Table 1.

### EXAMPLE 5

A fiber composition of the present invention was made in accordance with the process of the present invention. The fiber composition was made in the manner described in Example 4 except that the amount of the master batch flame retardant poly(trimethylene terephthalate) mixed with poly(trimethylene terephthalate) was such that the master batch flame retardant poly(trimethylene terephthalate) was present in the mixture at 5 wt. %. As a result, the zinc diethylphosphinate was present in the mixture at 0.75 wt. % (5 wt. % master batch flame retardant poly(trimethylene) terephthalate in mixture×15 wt. % zinc diethylphosphinate in master batch flame retardant poly(trimethylene terephthalate) and the melamine cyanurate was present in the mixture at 0.75 wt. %. Properties of the fiber are provided in Table 1.

### EXAMPLE 6

A fiber composition of the present invention was made in accordance with the process of the present invention. The fiber composition was made in the manner described in Example 2 except that the multi-filament fiber was drawn and textured on a commercially available drawing and texturing machine in a two draw process in which the multi-filament fiber was initially drawn at a temperature below its glass transition temperature, where the first drawing roll had a speed of 1030 m/min and the second drawing roll had a speed of 1060 m/min and the third drawing roll had a speed of 3090 m/min, and the drawn fiber was heated to a temperature of 200° C. for texturing. Properties of the fiber are provided in Table 1.

### EXAMPLE 7

A fiber composition of the present invention was made in accordance with the process of the present invention. The fiber composition was made in the manner described in Example 6 except the amount of the master batch flame retardant poly(trimethylene terephthalate) mixed with poly(trimethylene terephthalate) was such that the master batch flame retardant poly(trimethylene terephthalate) was present in the mixture at 10 wt. % and the zinc diethylphosphinate was present in the mixture at 2 wt. % (10 wt. % master batch flame retardant poly(trimethylene) terephthalate in mixture×20 wt. % zinc diethylphosphinate in master batch flame retardant poly(trimethylene terephthalate). Properties of the fiber are provided in Table 1.

### EXAMPLE 8

A fiber composition not in accordance with the present invention was made for comparative purposes. The fiber was made in the manner described in Example 1 except that no master batch of flame retardant poly(trimethylene terephthalate) was prepared, and only a poly(triemethylene terephthalate) polymer without any flame retardant was used to produce the fiber material. The properties of the fiber are shown in Table 1 as comparative fiber 1.

### EXAMPLE 9

A fiber composition not in accordance with the present invention was made for comparative purposes. The fiber was made in the manner described in Example 3 except that no master batch of flame retardant poly(trimethylene terephthalate) was prepared, and only a poly(triemethylene terephthalate) polymer without any flame retardant was used to produce the fiber material. The properties of the fiber are shown in Table 1 as comparative fiber 2.

### EXAMPLE 10

A fiber composition not in accordance with the present invention was made for comparative purposes. The fiber was made in the manner described in Example 6 except that no master batch of flame retardant poly(trimethylene terephthalate) was prepared, and only a poly(triemethylene terephthalate) polymer without any flame retardant was used to produce the fiber material. The properties of the fiber are shown in Table 1 as comparative fiber 3.

TABLE 1

| | Spinning | | | % | |
|---|---|---|---|---|---|
| | speed | | Tenacity | elongation | % |
| Sample | (m/min) | Denier | (g/d) | at break | bulk |
| 0.5 wt. % ZDP | 3000 | 1500 | 1.70 | 64 | 31.6 |
| (Example 1) | | | | | |
| 1 wt. % ZDP | 3000 | 1450 | 1.69 | 64 | 30.6 |
| (Example 2) | | | | | |
| Comparative | 3000 | 1500 | 1.85 | 62 | 33 |
| fiber 1 | | | | | |
| (Example 8) | | | | | |
| 1 wt. % ZDP | 3200 | 1485 | 1.70 | 61 | 33.5 |
| (Example 3) | | | | | |
| 0.375 wt. % | 3200 | 1481 | 1.72 | 60 | 35.5 |
| ZDP and 0.375 wt. | | | | | |
| % MC | | | | | |
| (Example 4) | | | | | |
| 0.75 wt. % ZDP | 3200 | 1480 | 1.70 | 61 | 34.2 |
| and 0.75 wt. % | | | | | |
| MC | | | | | |
| (Example 5) | | | | | |
| Comparative | 3200 | 1491 | 1.91 | 58 | |
| fiber 2 | | | | | |
| (Example 9) | | | | | |
| 1 wt. % ZDP | 3090 | 1532 | 1.64 | 75 | 28.9 |
| (Example 6) | | | | | |
| 2 wt. % ZDP | 3090 | 1516 | 1.61 | 75 | 28.3 |
| (Example 7) | | | | | |
| Comparative | 3090 | 1514 | 1.91 | 75 | 27.0 |
| fiber 3 | | | | | |
| (Example 10) | | | | | |

*ZDP = zinc diethylphosphinate
**MC = melamine cyanurate

Table 1 shows that the fibers of the present invention, while having reduced tenacity relative to poly(trimethylene terephthalate) fibers having no meltable phosphinate metal salt dispersed therein, have a tenacity of greater than 1.5.

### EXAMPLE 11

Carpets in accordance with the present invention were made from the muli-filament fibers (yarns) produced in Examples 1 and 2. The carpets formed from the fibers of Example 1 and Example 2 contained no other fibers. A carpet not in accordance with the present invention was also produced from the multi-filament fiber (yarn) produced in Example 7 for comparative purposes. The yarns were twisted at 4.75 twists-per-inch and Superba heat-set textured at 143° C. (290° F.). The yarns were then back wound, and then creeled and tufted as a 2 ft. wide band for each yarn item on a 5/32 gauge cutpile machine. Each resulting carpet was then beck-dyed in a dark red color and finished with a 600 filler load latex. A pill test was conducted 56 times on samples from the carpets, and a radiant panel test was conducted on a sample of each carpet. The results are shown in Table 2 below.

TABLE 2

| | Pill Test | Pill Test | Radiant |
|---|---|---|---|
| Sample | (Pass/Total) | (% pass) | flux |
| 0.5 wt. % ZDP | 39/56 | 70 | 0.30 |
| (Example 1) | | | |
| 1 wt. % ZDP | 34/56 | 61 | 0.21 |
| (Example 2) | | | |
| Comparative fiber 1 | 25/56 | 45 | 0.20 |
| (Example 8) | | | |

*ZDP = zinc diethylphosphinate

Table 2 shows that the carpets having poly(trimethylene terephthalate) fibers containing a flame retardant meltable phosphinate metal salt—zinc diethylphosphinate—exhibited reduced flammability relative to carpets having poly(triemethylene terephthalate) fibers with no meltable phosphinate metal salt as shown by the pill test, and may exhibit a significant increase in radiant flux energy required to ignite the carpet.

### EXAMPLE 12

Carpets in accordance with the present invention were made from the muli-filament fibers (yarns) produced in Examples 3, 4, and 5. The carpets formed from the fibers of Examples 3-5 contained no other fibers. A carpet not in accordance with the present invention was also produced from the multi-filament fiber (yarn) produced in Example 9 for comparative purposes. The yarns were twisted at 4.75 twists-per-inch and Superba heat-set textured at 143° C. (290° F.). The yarns were then back wound, and then creeled and tufted as a 6 ft. wide band for each yarn item on a 5/32 gauge cutpile machine. Each resulting carpet was then beck-dyed in a dark red color and finished with a 600 filler load latex. A pill test was conducted 24 times on samples from the carpets. The results are shown in Table 3 below.

TABLE 3

| | Pill Test | Pill Test |
|---|---|---|
| Sample | (Pass/Total) | (% pass) |
| 1 wt. % ZDP | 22/24 | 92 |
| (Example 3) | | |
| 0.375 wt. % ZDP & | 17/24 | 71 |
| 0.375 wt. % MC | | |
| (Example 4) | | |
| 0.75 wt. % ZDP & | 20/24 | 83 |
| 0.75 wt. % MC | | |
| (Example 5) | | |
| Comparative fiber 2 | 16/24 | 67 |
| (Example 9) | | |

* ZDP = zinc diethylphosphinate
**MC = melamine cyanurate

Table 3 shows that the carpets having poly(trimethylene terephthalate) fibers containing a flame retardant meltable phosphinate metal salt—zinc diethylphosphinate—exhibited reduced flammability relative to a carpet having poly(triemethylene terephthalate) fibers with no meltable phosphinate metal salt as shown by the pill test. It is interesting to note that the carpet containing more zinc diethylphosphinate than the other carpets showed the least flammability even though one carpet contained more total flame retardant, but less zinc diethylphosphinate.

### EXAMPLE 13

Carpets in accordance with the present invention were made from the muli-filament fibers (yarns) produced in Examples 6 and 7. The carpets formed from the fibers of Examples 6 and 7 contained no other fibers. A carpet not in accordance with the present invention was also produced from the multi-filament fiber (yarn) produced in Example 10 for comparative purposes. The yarns were twisted at 4.75 twists-per-inch and Superba heat-set textured at 143° C. (290° F.). The yarns were tufted at a 12 ft. width for each yarn item on a 5/32 gauge cutpile machine and on a 3/16 gauge cutpile machine. Two rolls of each resulting carpet gauge were then beck-dyed in a dark red color. One of these rolls of each carpet was re-dried through a second pass in a beck dryer. Three rolls of each resulting carpet gauge were then Kuster-dyed in a pink color. One of the Kuster-dyed carpet rolls was then re-dyed by Kuster-dyeing to a dark red color, and another one of the Kuster-dyed carpet rolls was re-dried in a beck dryer. The carpet samples were then finished with a 600 filler load latex. A pill test was conducted 32 or 48 times on samples from the carpets. The results are shown in Table 4 below.

TABLE 4

| | | | | | Kuster dyed |
|---|---|---|---|---|---|
| | | Beck dyed | | Kuster dyed | Kuster re- |
| | Beck dyed | (dark red) | Kuster dyed | (pink) | dyed |
| Sample | (dark red) | Beck redried | (pink) | Beck redried | (dark red) |
| 5/32 gauge | Pill test: 29/32 | Pill test: 47/48 | Pill test: 32/32 | Pill test: 32/32 | Pill test: 32/32 |
| 1 wt. % ZDP | % pass: 91 | % pass: 98 | % pass: 100 | % pass: 100 | % pass: 100 |
| PTT | | | | | |
| (example 6) | | | | | |
| 5/32 gauge | Pill test: 32/32 | Pill test: 48/48 | Pill test: 32/32 | Pill test: 32/32 | Pill test: 32/32 |
| 2 wt. % ZDP | % pass: 100 | % pass: 100 | % pass: 100 | % pass: 100 | % pass: 100 |
| PTT | | | | | |
| (example 7) | | | | | |
| 5/32 gauge | Pill test: 21/32 | Pill test: 33/48 | Pill test: 32/32 | Pill test: 32/32 | Pill test: 32/32 |
| comparative | % pass: 66 | % pass: 69 | % pass: 100 | % pass: 100 | % pass: 100 |
| fiber PTT | | | | | |
| (example 10) | | | | | |
| 3/16 gauge | Pill test: 28/32 | Pill test: 47/48 | Pill test: 32/32 | Pill test: 32/32 | Pill test: 32/32 |
| 1 wt. % ZDP | % pass: 87 | % pass: 98 | % pass: 100 | % pass: 100 | % pass: 100 |
| PTT | | | | | |
| (example 6) | | | | | |
| 3/16 gauge | Pill test: 29/32 | Pill test: 48/48 | Pill test: 32/32 | Pill test: 32/32 | Pill test: 32/32 |
| 2 wt. % ZDP | % pass: 91 | % pass: 100 | % pass: 100 | % pass: 100 | % pass: 100 |
| PTT | | | | | |
| (example 7) | | | | | |
| 3/16 gauge | Pill test: 15/32 | Pill test: 33/48 | Pill test: 32/32 | Pill test: 32/32 | Pill test: 31/32 |
| Comparative | % pass: 47 | % pass: 77 | % pass: 100 | % pass: 100 | % pass: 97 |
| fiber PTT | | | | | |
| (example 10) | | | | | |

* ZDP = zinc diethyl phosphinate

Table 4 shows that the carpets having poly(trimethylene terephthalate) fibers containing a flame retardant meltable phosphinate metal salt—zinc diethylphosphinate—exhibited reduced flammability relative to a carpet having poly(triemethylene terephthalate) fibers with no meltable phosphinate metal salt as shown by the pill test under test conditions where the carpet containing no meltable phosphinate metal salt did not show a 100% pass rate. The carpet containing 2 wt. % zinc diethyl phosphinate exhibited over a 90% pass rate for each type of carpet gauge and dyeing conditions tested.

What is claimed is:

1. A flame retardant polyester fiber, comprising:
(a) a polymer comprised of at least 75 wt. % poly(trimethylene terephthalate) comprised of at least 75 mol % trimethylene terephthalate; and
(b) a flame retardant comprising a phosphinate metal salt having a melting point of equal to or below 280° C. wherein said phosphinate metal salt comprises from 0.25 wt. % to 5 wt. % of the fiber, and wherein the phosphinate metal salt comprises at least 10 wt. % of the flame retardant;
said fiber having a tenacity of at least 1 g/d and a length at least 100 times its width.

2. The flame retardant polyester fiber of claim 1 wherein the flame retardant comprises from 0.5 wt. % to 2.5 wt. % of the fiber.

3. The flame retardant polyester fiber of claim 1 wherein the phosphinate metal salt comprises more than 50 wt. % of the flame retardant.

4. The flame retardant polyester fiber of claim 1 wherein the phosphinate metal salt is a zinc phosphinate having the formula (I) 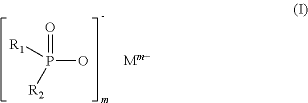
or a polymer thereof, where:
R¹ and R² are identical or different and are selected from the group consisting of hydrogen, C₁-C₁₈ alkyl, and C₁-C₁₈ aryl;
M is zinc; and
m is 2.

5. The flame retardant polyester fiber of claim 4 wherein the zinc phosphinate is zinc diethylphosphinate.

6. The flame retardant polyester fiber of claim 1 wherein the flame retardant further comprises a particulate non-fusible flame retardant compound having a mean particle size of 10 μm or less.

7. The flame retardant polyester fiber of claim 1 further comprising a polyamide or a polyester other than a polymer comprising at least 75 mol % trimethylene terephthalate.

8. A material, comprising a plurality of fibers wherein at least 5% of the fibers are comprised of (a) a polymer comprised of at least 75 wt. % poly(trimethylene terephthalate) comprised of at least 75 mol % trimethylene terephthalate; and (b) a flame retardant comprising a flame retardant phosphinate metal salt having a melting point equal to or below 280° C.; wherein the phosphinate metal salt comprises from 0.25 wt. % to 5 wt. % of the flame retardant containing PTT polymer fibers and wherein the phosphinate metal salt comprises at least 10 wt. % of the flame retardant of the flame retardant containing PTT polymer fibers.

9. The material of claim 8 wherein the phosphinate metal salt is a zinc phosphinate having the formula (I) 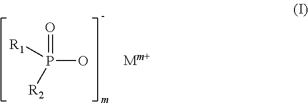
or a polymer thereof, where:
R¹ and R² are identical or different and are selected from the group consisting of hydrogen, C₁-C₁₈ alkyl, and C₁-C₁₈ aryl;
M is zinc; and
m is 2.

10. The material of claim 9 wherein the zinc phosphinate is zinc diethylphosphinate.

11. The material of claims 8 wherein the flame retardant containing fibers have a tenacity of at least 1 g/d.

12. The material of claims 8 wherein the material is a carpet.

13. The carpet material of claim 12 having a flame resistance such that the probability that a methanamine tablet ignited on the carpet material in a pill test will char the carpet a distance of at most 7.62 cm from the tablet is at least 90%.

14. The carpet material of claim 12 wherein the carpet has an average minimum radiant flux of at least 0.22 watts per square centimeter.

15. The material of claims 8 wherein the material is a textile.

16. A process for producing a flame retardant polyester fiber, comprising:
mixing 1) a flame retardant comprising a phosphinate metal salt and 2) a polymer comprising at least 75 mol % trimethylene terephthalate at a temperature of from 180° C. to 280° C. to form a mixture; and
passing the mixture through a spinneret to form a fiber, wherein:
(a) the temperature at which the flame retardant and the polymer are mixed is selected so that the phosphinate metal salt and the polymer each have a melting point below the selected temperature;
(b) the flame retardant is selected so the phosphinate metal salt comprises at least 10 wt. % of the flame retardant;
(c) the amount of flame retardant mixed in the mixture is selected so the phosphinate metal salt comprises from 0.25 wt. % to 5 wt. % of the mixture; and
(d) the amount of flame retardant mixed in the mixture is selected to provide a fiber having a tenacity of at least 1 g/d upon passing the mixture through the spinneret to form the fiber.

17. The process of claim 16 wherein the phosphinate metal salt has a melting point equal to or below 280° C.

18. The process of claim 16 wherein the phosphinate metal salt is a zinc phosphinate having a melting point equal to or below 280° C. and having the formula (I) 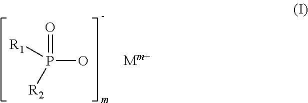
or a polymer thereof, where:
R¹ and R² are identical or different and are selected from the group consisting of hydrogen, C₁-C₁₈ alkyl, and C₁-C₁₈ aryl;
M is zinc; and
m is 2.

19. The process of claim 18 wherein the zinc phosphinate is zinc diethylphosphinate.

20. The process of claim 16 wherein the flame retardant further comprises a particulate non-fusible flame retardant compound.

21. The process of claim 16 further comprising the steps of cooling the mixture to form a solid and subsequently heating the solid to a temperature at which the solid melts to reform the mixture prior to pumping the mixture through a spinneret to form a fiber.

22. The process of claim 16 wherein the flame retardant further comprises a masterbatch polymer, and where the temperature at which the flame retardant and the polymer comprising at least 75 wt. % poly(trimethylene terephthalate) comprised of at least 75 mol % trimethylene terephthalate are mixed is selected so that the phosphinate metal salt, the masterbatch polymer, and the polymer comprising at least 75 wt. % poly(trimethylene terephthalate) comprised of at least 75 mol % trimethylene terephthalate each have a melting point below the selected temperature.

23. The process of claim 22 wherein the masterbatch polymer is selected from the group consisting of polyamides and polyesters.
